(19) United States
(12) Patent Application Publication
(10) Pub. No.: US 2015/0258545 A1
(43) Pub. Date: Sep. 17, 2015

(54) MICROFLUIDIC DEVICES AND METHODS FOR CONTROLLING A MICROFLUIDIC DEVICE

(71) Applicant: AGENCY FOR SCIENCE, TECHNOLOGY AND RESEARCH, Singapore (SG)

(72) Inventors: Puttachat KHUNTONTONG, Singapore (SG); Zhiping WANG, Singapore (SG); Yong Chear SOH, Singapore (SG); Sai Kiang LIM, Singapore (SG); Soon Sim TAN, Singapore (SG)

(21) Appl. No.: 14/658,081

(22) Filed: Mar. 13, 2015

(30) Foreign Application Priority Data
Mar. 14, 2014 (SG) 10201400682X

(51) Int. Cl. B01L 3/00

(52) U.S. Cl. CPC B01L 3/502738; B01L 3/502715; B01L 3/502761; B01L 3/502723; B01L 2300/0877; B01L 2300/087; B01L 2400/0694; B01L 2200/0647; B01L 2200/0631; B01L 2200/0621

(57) ABSTRACT

According to various embodiments, a microfluidic device may be provided. The microfluidic device may include: a plurality of valves connected to respective channels; a plurality of chambers, including a mixing chamber, a sample collection chamber, and a waste collection chamber; a binding member configured to bind biomolecules; and wherein flow of a liquid between the plurality of chambers is controlled by selectively opening and closing each valve of the plurality of valves to selectively allow air to be released from the channels connected to the respective valve.

### CROSS-REFERENCE TO RELATED APPLICATIONS

The present application claims the benefit of the Singapore patent application No. 10201400682X filed on 14 Mar. 2014, the entire contents of which are incorporated herein by reference for all purposes.

### TECHNICAL FIELD

Embodiments relate generally to microfluidic devices and methods for controlling a microfluidic device.

### BACKGROUND

Isolating Extracellular Vesicles (EVs) from cell culture supernatants or body fluids is important in various applications. Thus, there may be a need for an efficient and effective way for isolating extracellular vesicles.

### SUMMARY

According to various embodiments, a microfluidic device may be provided. The microfluidic device may include: a plurality of valves connected to respective channels; a plurality of chambers, including a mixing chamber, a sample collection chamber, and a waste collection chamber; a binding member configured to bind biomolecules; and wherein flow of a liquid between the plurality of chambers is controlled by selectively opening and closing each valve of the plurality of valves to selectively allow air to be released from the channels connected to the respective valve.

According to various embodiments, a method for controlling a microfluidic device may be provided. The microfluidic device may include a plurality of valves connected to respective channels, a plurality of chambers, including a mixing chamber, a sample collection chamber, and a waste collection chamber, and a binding member configured to bind biomolecules. The method may include controlling flow of a liquid between the plurality of chambers by selectively opening and closing each valve of the plurality of valves to selectively allow air to be released from the channels connected to the respective valve.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments are described with reference to the following drawings, in which:

FIG. 1A shows a microfluidic device according to various embodiments;

FIG. 1B shows a microfluidic device according to various embodiments;

FIG. 1C shows a flow diagram illustrating a method for controlling a microfluidic device according to various embodiments;

FIG. 2 shows a microfluidic chip according to various embodiments;

FIG. 3 shows a flow diagram illustrating a process of isolating microvesicles on the microfluidic chip according to various embodiments;

FIG. 4 shows an illustration of a comparison of mixing efficiency between micro mixing according to various embodiments and a conventional method;

FIG. 5. shows an illustration of a zoom-in picture of preloaded streptavidin polystyrene beads on chip according to various embodiments;

FIG. 6 shows an illustration of an effect of flow-rates to capture microvesicles on binding surface according to various embodiments;

FIG. 7A, FIG. 7B, FIG. 7C, and FIG. 7D show illustrations of a microfluidic device according to various embodiments, illustrating valves and connecting channels to control liquid movement;

FIG. 8 shows a cross sectional view of the microfluidic chip and a liquid path according to various embodiments; and

FIG. 9 shows an illustration including a cross sectional view of a chip, for example presenting positions of passive valves, according to various embodiments.

### DESCRIPTION

Embodiments described below in context of the devices are analogously valid for the respective methods, and vice versa. Furthermore, it will be understood that the embodiments described below may be combined, for example, a part of one embodiment may be combined with a part of another embodiment.

In this context, the microfluidic device as described in this description may include a memory which is for example used in the processing carried out in the microfluidic device. A memory used in the embodiments may be a volatile memory, for example a DRAM (Dynamic Random Access Memory) or a non-volatile memory, for example a PROM (Programmable Read Only Memory), an EPROM (Erasable PROM), EEPROM (Electrically Erasable PROM), or a flash memory, e.g., a floating gate memory, a charge trapping memory, an MRAM (Magnetoresistive Random Access Memory) or a PCRAM (Phase Change Random Access Memory).

In an embodiment, a “circuit” may be understood as any kind of a logic implementing entity, which may be special purpose circuitry or a processor executing software stored in a memory, firmware, or any combination thereof. Thus, in an embodiment, a “circuit” may be a hard-wired logic circuit or a programmable logic circuit such as a programmable processor, e.g. a microprocessor (e.g. a Complex Instruction Set Computer (CISC) processor or a Reduced Instruction Set Computer (RISC) processor). A “circuit” may also be a processor executing software, e.g. any kind of computer program, e.g. a computer program using a virtual machine code such as e.g. Java. Any other kind of implementation of the respective functions which will be described in more detail below may also be understood as a “circuit” in accordance with an alternative embodiment.

Isolating Extracellular Vesicles (EVs) from cell culture supernatants or body fluids is important in various applications. According to various embodiments, efficient and effective ways for isolating extracellular vesicles may be provided.

Conventional procedures to isolate Extracellular Vesicles (EVs) from cell culture supernatants or body fluids include techniques such as differential ultracentrifugation gel filtration or polymerbased precipitation. Examples of EVs may include microvesicles, ectosomes, membrane particles, exosome-like vesicles, apoptotic bodies, prostasomes, oncosomes, or exosomes.

Differential ultracentrifugation may involve a systematic process of spinning down the biological samples to remove organelles and cell debris from cell lysis and then pelleting down the small membrane vesicles. Gel filtration may be a chromatographic method in which molecules in solution may be separated by their size and molecular weight. Polymer-based precipitation may involve the use of polymers such as PEG to precipitate macromolecules. All techniques essentially may isolate EVs on the basis of size and may not distinguish EVs from similarly sized macromolecules such as protein aggregates. Therefore the end products may be essentially crude preparations of macromolecules.

A method of isolation for microparticles from biological samples using the highly specific binding affinities of certain phospholipids for their ligands may be applied. It is to be noted that the term “microparticles” may be replaced by the term extracellular vesicles (EVs). The isolation principles may utilize the binding of GM1 gangliosides to Cholera Toxin B chain (CTB) and phosphotidylserine to Annexin V (AV). The isolation of EVs according to their affinity for either CTB or AV may use a magnetic bead-based technology.

Conventional procedures for isolation CTB- or AV-binding EVs by magnetic bead-based technology assay may be highly laborious with multiple manual manipulation steps and may requires a high level of technical skill for reproducible accuracy and precision.

Many laboratories are currently working on biomarkers discovery in microvesicles. The commonly used methods of isolation for these vesicles are well established but time consuming. With the devices (for example microfluidic chip) and methods according to various embodiments, fast isolation may be achieved with reasonable yield. This may make the devices and methods according to various embodiments attractive to researchers and clinical laboratories.

According to various embodiments, devices and methods may be provided which increase the output for the assay and reduce the reliance on technical skill for repeated manual manipulation through automation. According to various embodiments, high precision and accurate robotic equipment may be provided and used to load biological samples for the isolation CTB- or AV-binding EVs on a microfluidic platform.

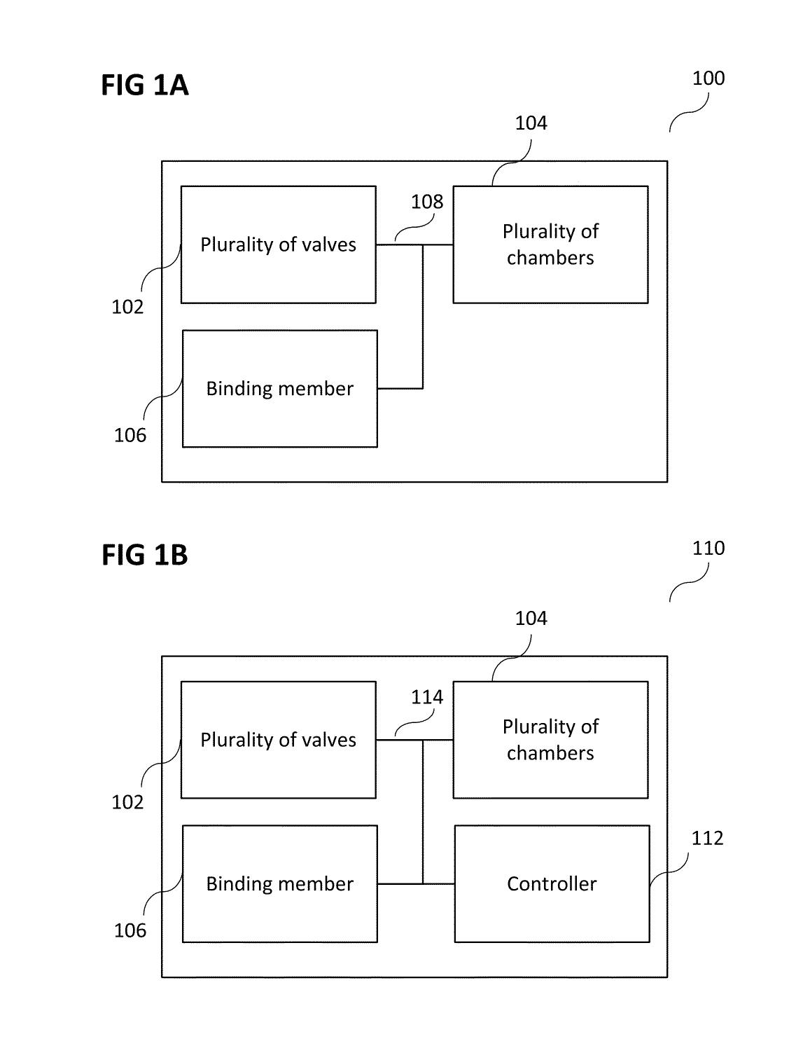

FIG. 1A shows a microfluidic device 100 according to various embodiments. The microfluidic device 100 may be configured to isolate specific micro vesicles. The microfluidic device 100 may include a plurality of valves 102 connected to respective channels (which may be included in the microfluidic device). The microfluidic device 100 may further include a plurality of chambers 104, including a mixing chamber, a sample collection chamber, and a waste collection chamber. The microfluidic device 100 may further include a binding member 106 configured to bind biomolecules. Flow of a liquid between the plurality of chambers 104 may be controlled by selectively opening and closing each valve of the plurality of valves 102 to selectively allow air to be released from the channels connected to the respective valve. The plurality of valves 102, the plurality of chambers 104, and the binding member 106 may be coupled, for example mechanically coupled, like indicated by lines 108.

In other words, the microfluidic device may control flow of liquid between various chambers by opening or closing valves, which allows air to flow out of a pre-determined chamber of the plurality of chambers and a liquid into the pre-determined chamber.

FIG. 1B shows a microfluidic device 110 according to various embodiments. The microfluidic device 110 may, similar to the microfluidic device 100 of FIG. 1A, be configured to isolate specific micro vesicles. The microfluidic device 110 may, similar to the microfluidic device 100 of FIG. 1A, include a plurality of valves 102 connected to respective channels (which may be included in the microfluidic device). The microfluidic device 110 may, similar to the microfluidic device 100 of FIG. 1A, further include a plurality of chambers 104, including a mixing chamber, a sample collection chamber, and a waste collection chamber. The microfluidic device 110 may, similar to the microfluidic device 100 of FIG. 1A, further include a binding member 106 configured to bind vesicles. Flow of a liquid between the plurality of chambers 104 may be controlled by selectively opening and closing each valve of the plurality of valves 102 to selectively allow air to be released from the channels connected to the respective valve. The microfluidic device 110 may further include a controller 112, like will be described in more detail below. The plurality of valves 102, the plurality of chambers 104, the binding member 106, and the controller 112 may be coupled, for example mechanically coupled, like indicated by lines 114.

According to various embodiments, the controller 112 may be configured to control the selectively opening and closing each valve of the plurality of valves 102 to selectively allow air to be released from the channels connected to the respective valve.

According to various embodiments, the plurality of valves 102 may include or may be a first valve connected to the mixing chamber, a second valve connected to the sample collection chamber, and a third valve connected to the waste connection chamber.

According to various embodiments, the biomolecules may include or may be microvesicles, protein, DNA, antibody, and/or antigen.

According to various embodiments, the first valve may be configured to release air from the mixing chamber and allow liquid to flow into the mixing chamber when the first valve is open.

According to various embodiments, the third valve may be configured to release air from the waste collection chamber and allow liquid to flow from the mixing chamber via the binding member to the waste collection chamber when the third valve is open.

According to various embodiments, the second valve may be configured to release air from the sample collection chamber and allow liquid to flow from the mixing chamber via the binding member to the sample collection chamber when the second valve is open.

According to various embodiments, the binding member 106 may include or may be made from particles coated with streptavidin or other biomolecules for example protein, antibody or antigen.

According to various embodiments, the particles may include or may be made from polystyrene beads, glass beads or bumps formed on a substrate surface.

According to various embodiments, the microfluidic device 110 may be configured to wash out other particles by 1×PBS or others solutions.

According to various embodiments, the microfluidic device 110 may be configured to elute biomolecules out by flowing elusion solution through the binding member 106.

FIG. 1C shows a flow diagram 116 illustrating a method for controlling a microfluidic device according to various embodiments (for example one of the microfluidic devices shown in FIG. 1A or FIG. 1B). The microfluidic device may include a plurality of valves connected to respective channels, a plurality of chambers, including a mixing chamber, a sample collection chamber, and a waste collection chamber, and a binding member configured to bind biomolecules. In 118, flow of a liquid between the plurality of chambers may be controlled by selectively opening and closing each valve of the plurality of valves to selectively allow air to be released from the channels connected to the respective valve.

According to various embodiments, the method may further include controlling the selectively opening and closing each valve of the plurality of valves to selectively allow air to be released from the channels connected to the respective valve.

According to various embodiments, the plurality of valves may include a first valve connected to the mixing chamber, a second valve connected to the sample collection chamber, and a third valve connected to the waste connection chamber.

According to various embodiments, the first valve, when it is open, may allow release of air from the mixing chamber and may allow liquid to flow into the mixing chamber.

According to various embodiments, the third valve, when it is open, may allow release of air from the waste collection chamber and may allow liquid to flow from the mixing chamber via the binding member to the waste collection chamber.

According to various embodiments, the biomolecules may include or may be microvesicles, protein, DNA, antibody, and/or antigen.

According to various embodiments, the second valve, when it is open, may allow release of air from the sample collection chamber and may allow liquid to flow from the mixing chamber via the binding member to the sample collection chamber.

According to various embodiments, the binding member may include or may be made from particles coated with streptavidin, antibody and/or antigen.

According to various embodiments, the particles may include or may be made from polystyrene beads, glass beads and/or bumps formed on a substrate surface.

According to various embodiments, the method may further include washing out other particles by 1×PBS or other solutions.

According to various embodiments, the method may further include eluting biomolecules out by flowing elusion solution through the binding member.

According to various embodiments, microfluidic devices and methods for isolation of extracellular membrane vesicles may be provided.

According to various embodiments, micro vesicles may be isolated by using a microfluidic platform.

According to various embodiments, the enrichment system for CTB- or AV-binding EVs may include the following two (for example integrated) components:

1. A microfluidic-based chip including a mixer, a binding member (for example a binding surface), a waste (collection) chamber and a sample collection chamber; and

2. An automated system for sample loading, chemical dispensing and flow control.

According to various embodiments, to isolate CTB- or AV-binding EVs, the biological samples may be loaded and mixed with specific ligands to bind EVs. The ligand-bound EVs may then be immobilized and the rest may be washed away. Finally, the ligand-bound EVs may be released. The chip (in other words: the chip design) may include of a self-contained sample collection chamber, a self-contained waste chamber and flow control. Multiple samples may be tested on one chip simultaneously.

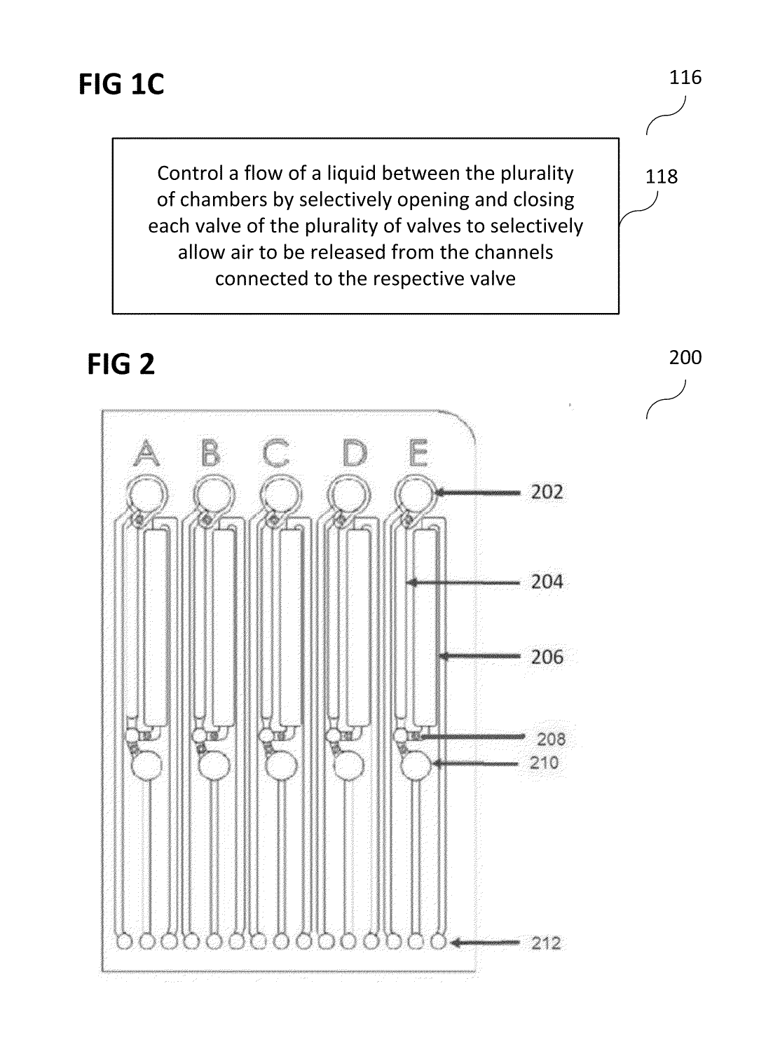

FIG. 2 shows a microfluidic chip 200 (in other words: a microfluidic device) according to various embodiments, for example for running five samples (A to E) at one time. As shown in FIG. 2, a plurality (for example five) running samples of isolation of microvesicles on the microfluidic chip 200 may be provided. The microfluidic chip 200 may include the same or similar structure for each of the samples (for example like indicated by A, B, C, D, and E in FIG. 2). A mixing chamber 202 may be configured to mix. Furthermore, a binding surface 204, a waste chamber 206, and sample collection chamber 210 may be provided (for example in the same way or in a similar manner for each of the plurality of samples). For each for the plurality of samples, flow control members 208, 212 (for example a plurality of valves) may be provided, for example to control the flow between the various chambers.

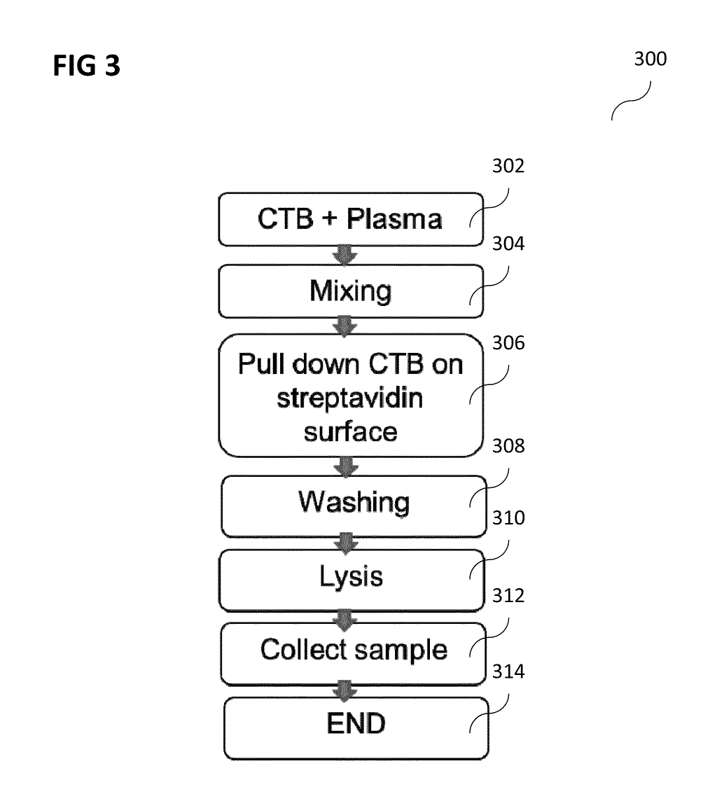

FIG. 3 shows a flow diagram 300 illustrating a process of isolating microvesicles on the microfluidic chip according to various embodiments. As shown in FIG. 3, the process of conjugation and isolation of vesicles on the microfluidic chip may be as follows: Firstly, in 302, CTB and human plasma may be loaded in the mixing chamber on the chip. In 304, the mixing may be conducted by agitating the membrane underneath the chamber. The exclusiveness of CTB-bound EVs (CTB-EVs) and AV-bound EVs (AV-EVs) indicates that the lipid compositions of these two EVs are different and the two EVs are thus derived from physically and functionally different microdomains in the plasma membranes. Biotinylated CTB-bound and biotinylated AV-bound microvesicles may occur during mixing and flow through the binding surface where they could be captured by streptavidin-functionalized surfaces. Such surfaces may be formed by streptavidin coating. Immobilization between biotin-streptavidin may occur on the functional surface. Supernatant may flow to waste chamber. A coated streptavidin surface may be prepared on the binding surface area. The preparation may be either directly on the channel surface during chip fabrication or may be done by loading coated particles at point of operation. Then, in 308, PBS (Phosphate buffered saline) washing solution may flow through the binding surface for three times. Finally, in 310, lysis solution may flow through the binding surface to release vesicles from the surface. In 312, the user may collect vesicles from the sample collection chamber. The process may end in 314.

In the following, optimization of mixing will be described.

To optimize mixing condition for highest binding of CTBs to plasma EVs, plasma samples and biotinylated CTB may be mixed in the mixing chamber by agitation at different frequencies for different periods of time. The efficiency of CTB binding by EVs may be determined by assaying for the level of CD81 in the CTB-bound complex by ELISA. CD81 is a well-established exosome-associated biomarker.

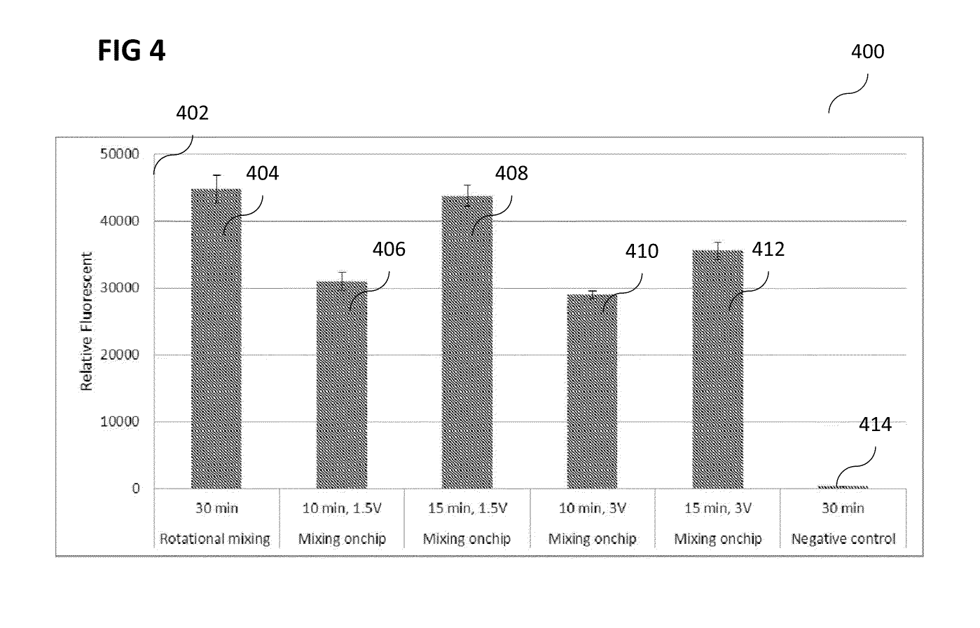

FIG. 4 shows an illustration 400 of a comparison of mixing efficiency between micro mixing according to various embodiments and a conventional method. A vertical axis 402 illustrates the relative fluorescent. A first bar 404 shows the relative fluorescent for 30 minutes of rotational mixing. A second bar 406 shows the relative fluorescent for 10 minutes of mixing on chip at 1.5V. A third bar 408 shows the relative fluorescent for 15 minutes of mixing on chip at 1.5V. A fourth bar 410 shows the relative fluorescent for 10 minutes of mixing on chip at 3V. A fifth bar 412 shows the relative fluorescent for 15 minutes of mixing on chip at 3V. A sixth bar 414 shows the relative fluorescent for negative control.

It can be seen from FIG. 4 that 15 minutes 1.5V on chip mixing was as efficient as 30 minutes of conventional rotational mixing.

In the following, microvesicles binding to surface according to various embodiments will be described.

Biotinylated CTB-bound microvesicles in the mixing chamber may be flowed through the binding channel where they may be captured by streptavidin-functionalized surfaces. Such surfaces may be formed by streptavidin coated particles such as polystyrene beads and glass beads.

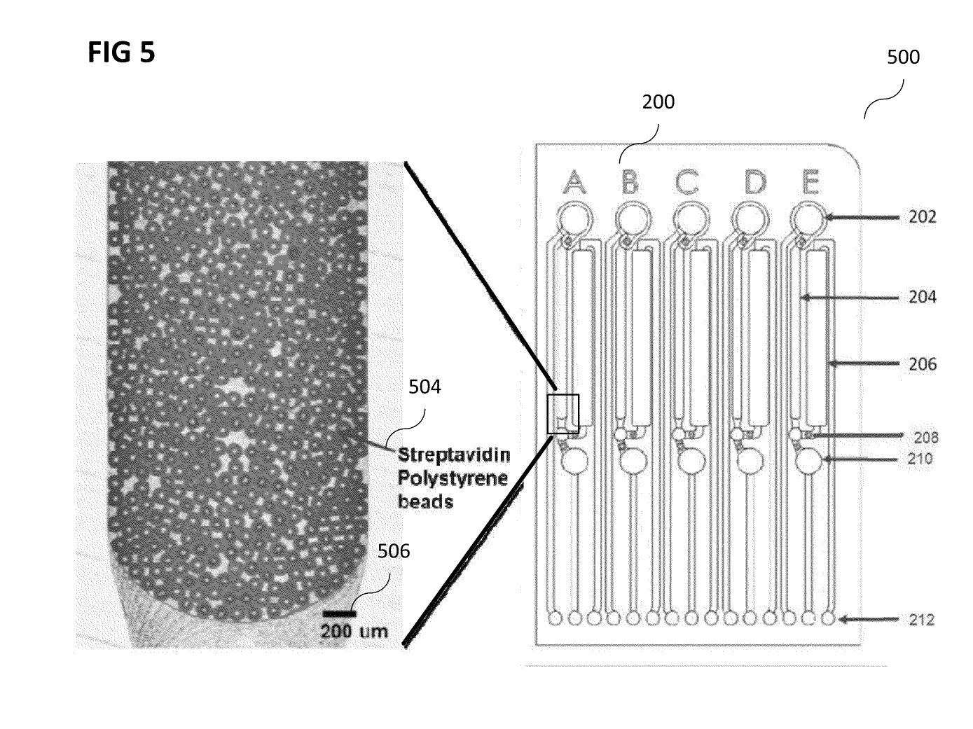

FIG. 5. shows an illustration 500 of a zoom-in picture of preloaded streptavidin polystyrene beads on chip according to various embodiments.

FIG. 5 presents a picture of streptavidin polystyrene beads 504 which were preloaded onto the chip (for example the chip 200 like described with reference to FIG. 2). Microvesicles immobilized on the binding surface via biotin-streptavidin binding may then be washed to remove none specific binding on surface. An exemplary scale 506 is shown. According to various embodiments, a microfluidic chip may for example have dimension of 50 mm×75 mm×12 mm. The mixing chamber may for example have diameter of 2 to 10 mm. The valves may for example have a diameter of about 1 to 5 mm. Microfluidic channels at the binding surface may for example have dimension of 150 um in depth and 1 to 2 mm in width. However, it will be understood that various embodiments may be provided in other dimensions or size compared to the dimension or size of FIG. 5.

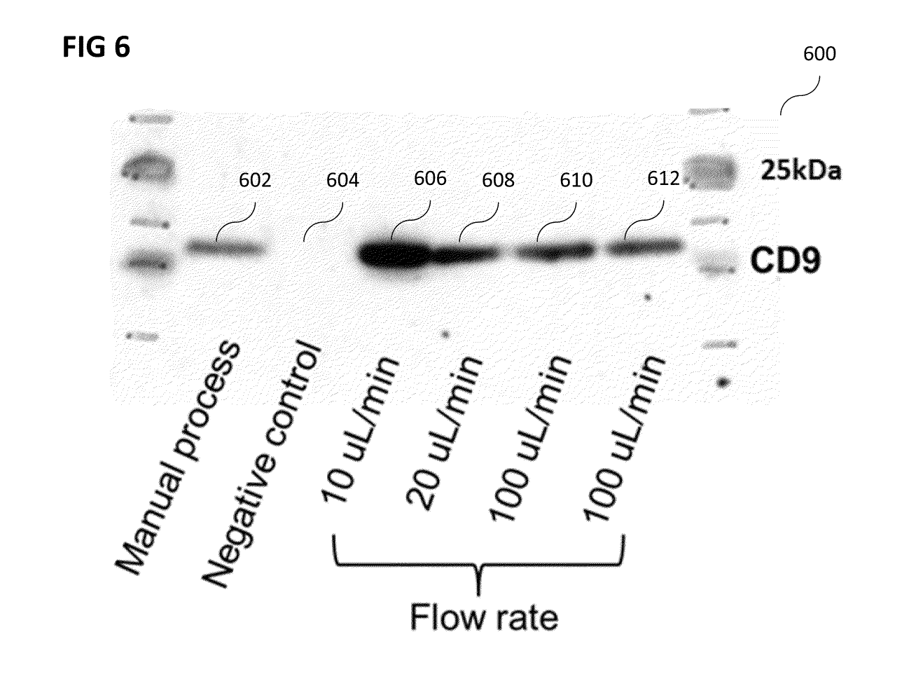

FIG. 6 shows an illustration 600 of an effect of flow-rates to capture microvesicles on binding surface according to various embodiments. After isolation of the microvesicles using biotinylated CTB, they were lysed, resolved on a protein gel, electroblotted onto a nitrocellulose membrane and probed with a primary antibody followed by horseradish peroxidase-coupled secondary antibodies against CD9. CD9 is a well-established general marker for microvesicles. A first marker 602 may indicate a manual process. A second marker 604 may indicate negative control. A third marker 606 may indicate a flow rate of 100 min (wherein it will be understood that “μl” (microliter) may also be written as “ul”). A fourth marker 608 may indicate a flow rate of 20 μl/min. A fifth marker 610 may indicate a flow rate of 100 μl/min. A sixth marker 612 may indicate a flow rate of 100 μl/min (for example in a repeated test).

Using flow rates from 10 μl/min to 100 μl/min, CTB-binding EVs were most efficiently captured as evidenced by the high level of CD9 in the isolated EVs. The marks at the left and right portion of FIG. 6 are standard protein ladder. The protein ladder presents with a protein size.

In the following, a waste chamber and sample collection according to various embodiments will be described.

According to various embodiments, to minimize cross-contamination and ease the waste treatment, an on-chip self-contained waste chamber and sample collection chamber may be provided. As such, no exit outlet and connectors may be required.

In the following, flow control according to various embodiments will be described.

According to various embodiments, flow control may be realized by a valve system.

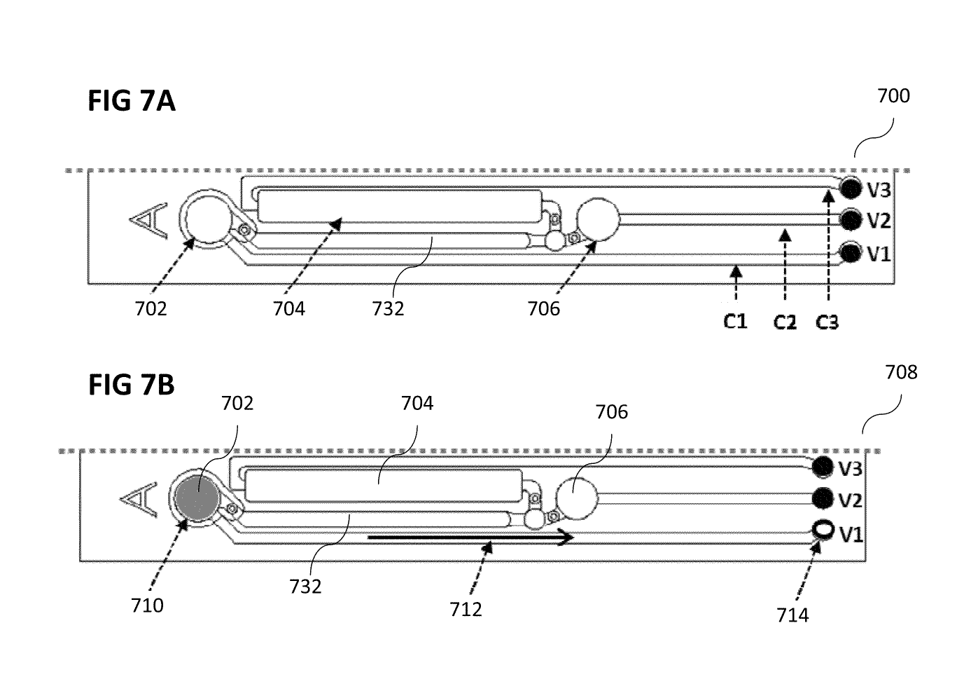

FIG. 7A shows an illustration 700 of a microfluidic device (for example corresponding to the portion for sample A of the device 200 shown in FIG. 2) according to various embodiments, illustrating valves and connecting channels to control liquid movement.

As shown in FIG. 7A, three sets of valves V1, V2, and V3, may be used for each running sample. Each valve connects to a chamber. For example the first valve V1 may be connected to a first channel C1, the second valve V2 may be connected to a second channel C2, and the third valve V3 may be connected to a third channel C3. A binding surface 732 may be provided.

When a valve is open, fluid may flow in to the chamber or may flow out from the chamber. As shown in FIG. 7A, V1 connects to a mixing chamber 702 via channel C1, V2 connects to the sample collection chamber 706 via channel C2 and V3 connects to a waste chamber 704 via channel C3. Valve operation may be executed manually or automatically. An automated system according to various embodiments may also control liquid loading and mixing.

FIG. 7B shows an illustration 708 in the valve operation. The microfluidic device shown in FIG. 7B is the microfluidic device shown in FIG. 7A, so that the same reference signs may be used and duplicate description of portions of the microfluidic device may be omitted.

When liquid is loaded into the mixing chamber 702 (like illustrated in 710), V1 may be open (like indicated by 714), and both V2 and V3 may be closed. Air in the chamber (for example the mixing chamber 702) may be released (like indicated by arrow 712 which indicates air release out), therefore the pressure in the chamber (for example the mixing chamber 702) may be released which may allow that liquid can be replaced in the chamber. On the other hand, when a valve is closed, pressure will build up in that chamber. Thus liquid cannot flow in a closed chamber.

FIG. 7B illustrates the operation of V1 during loading liquid in the mixing chamber 702. Air from the chamber (for example the mixing chamber 702) may be released out when V1 is on while V2 and V3 are still closed.

FIG. 7C shows an illustration 716 of the microfluidic device of FIG. 7A and FIG. 7B in a subsequent operation state (so that the same reference signs may be used and duplicate description of portions of the microfluidic device may be omitted).

When pressure is applied to the liquid in the mixing chamber 702 while V3 is open (like illustrated by 722), and while V1 and V2 are closed, liquid (like illustrated by 718) may flow through the binding surface 732 and move to the waste chamber 704 as shown in FIG. 7C. Air may be released out from the waster chamber 704, like illustrated by 720.

FIG. 7C illustrates the operation of V3 during liquid flow from mixing chamber 702 to waste chamber 704. Air from the waste chamber may be released when V3 is open while V1 and V1 are closed.

FIG. 7D shows an illustration 724 of the microfluidic device of FIG. 7A, FIG. 7B, and FIG. 7C in a subsequent operation state (so that the same reference signs may be used and duplicate description of portions of the microfluidic device may be omitted).

When liquid flows from the mixing chamber 702 to the sample collection chamber 706, V2 may be open (like indicated by 730) to release pressure (in other words: to provide air release out; like indicated by 728) in the collection chamber 706, while V1 and V3 are closed (like illustrated in FIG. 7D).

FIG. 7D illustrates operation of V2 during liquid flow from the mixing chamber 702 to the collecting chamber 706. Air from the collecting chamber is released when V2 is open while V1 and V3 are closed.

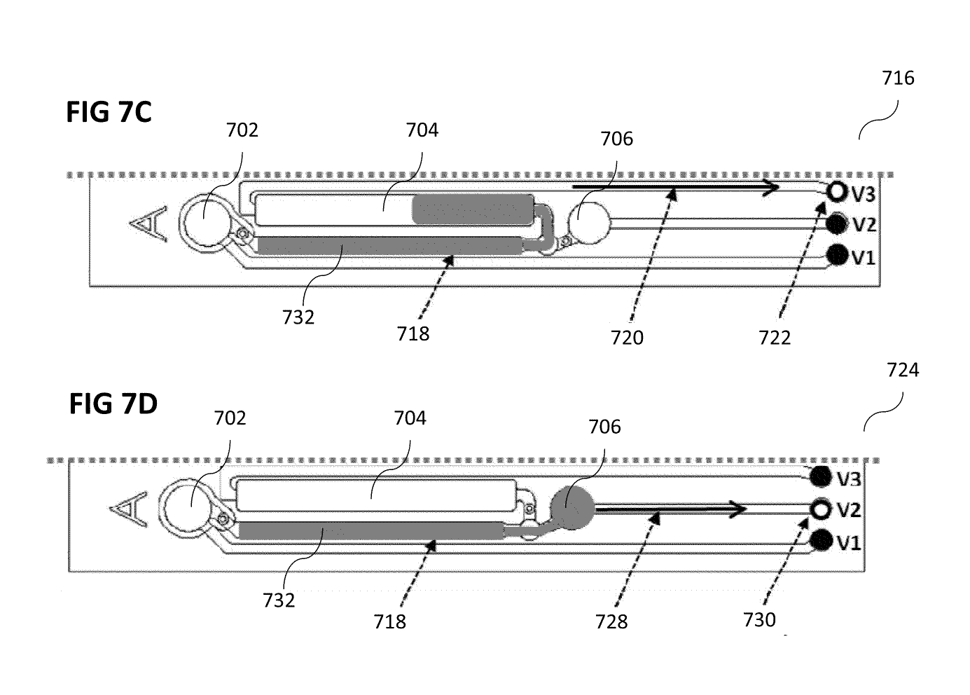

FIG. 8 shows a cross sectional view 800 of the microfluidic chip (in other words: microfluidic device) and a liquid path 802 from the mixing chamber 702 to the collection chamber 706 according to various embodiments. The microfluidic device shown in FIG. 8 may be the same or similar to the microfluidic device of FIG. 7A, so that the same reference signs may be used and duplicate description of portions of the microfluidic device may be omitted.

To prevent liquid overflow from a chamber to a valve, the flow path may be designed in such a way that liquid fills the chamber from one side (for example from the left side in FIG. 8) and air is released out from top of the chamber on the other side (for example from the right side in FIG. 8). Air release at C2 is indicated by 804. Valve V2 may be open for releasing air in the collection chamber 706, and therefore liquid may flow in without over flow to valve V2.

In the following, a passive valve according to various embodiments will be described.

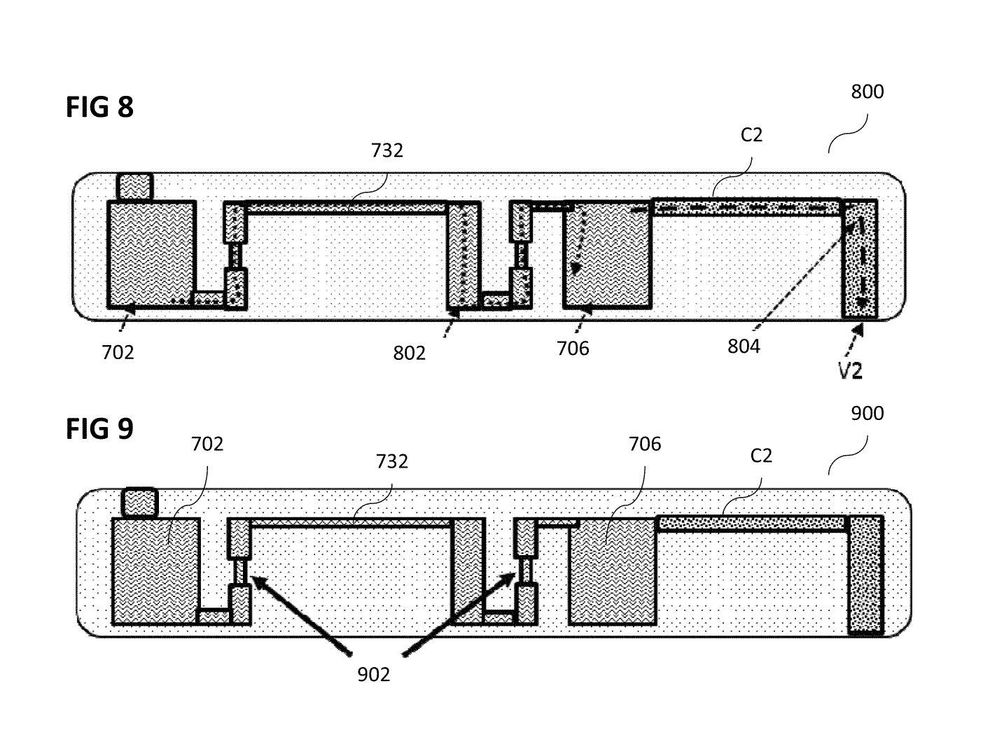

FIG. 9 shows an illustration 900 including a cross sectional view of a chip (for example microfluidic chip; in other words: microfluidic device), for example presenting positions of passive valves 902, according to various embodiments. The microfluidic device shown in FIG. 9 may be the same or similar to the microfluidic device of FIG. 7A, so that the same reference signs may be used and duplicate description of portions of the microfluidic device may be omitted.

Passive valves may be designed to control non-defined flow. A passive valve may have different channel dimensions which may exhibit different flow resistance. A small channel dimension may require high pressure for liquid to flow through. FIG. 9 shows a cross-section of a liquid path from the mixing chamber 702 to the sample collection chamber 708 through the binding surface 732 where two passive valves 902 are used.

According to various embodiments, a microfluidics device (in other words: a microfluidic device) and a method for specific isolation of micro vesicles using lipid membrane may be provided.

According to various embodiments, a microfluidic device for isolation of specific micro-vesicles at lipid membrane may be provided. The microfluidic device may include: at least one sample loading port, connecting to one micromixing chamber through a channel; a binding surface for specific vesicles, connecting to a sample collection chamber through a channel and a waste collection chamber through another channel at least three valves, with one of them connecting to the said micromixing chamber through a channel; another one connecting to sample collection chamber; another one connecting to waste collection chamber; such that opening of one valve causes the liquid to move from one location to another location connected with the said valve under the pressure applied at the loading port. The said binding surface may have other specific binding functions for protein A/G and antibody.

According to various embodiments, the binding surface may be formed by streptavidin coated particles.

According to various embodiments, the particles may be or may include polystyrene beads.

According to various embodiments, the particles may be glass beads.

According to various embodiments, a method for specific isolation of micro vesicles at lipid membrane and integration of the process into the microfluidic platform may be provided.

According to various embodiments, the microfluidic platform may include an integrated chip with functional micro elements such as micro-mixer, micro-filter, micro-reactor, micro-valves, a micro-pump, and a system control. The chip may include the micro mixer, a binding surface of vesicles, a self-contained sample collection chamber, a self-contained waste management chamber and a liquid direction control.

According to various embodiments, manifold valves on chip may be provided to control liquid flow, wherein liquid flow between the plurality of chambers is controlled by selectively opening and closing each valve of the plurality of valves to selectively allow air to be released from the channel or channels connecting to the respective valve or valves.

According to various embodiments, selectively binding of vesicles before flow through the binding surface in the chip may be provided. Only vesicles which are bio-marker tagged may be bonded to the surface.

According to various embodiments, washing out of other particles by 1×PBS may be provided, where the waste may flow to the waste management chamber.

According to various embodiments, vesicles may be eluted out by flowing elusion solution through the binding surface and moved to the collection chamber.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A microfluidic device comprising:
a plurality of valves connected to respective channels;
a plurality of chambers, comprising a mixing chamber, a sample collection chamber, and a waste collection chamber;
a binding member configured to bind biomolecules; and
wherein flow of a liquid between the plurality of chambers is controlled by selectively opening and closing each valve of the plurality of valves to selectively allow air to be released from the channels connected to the respective valve.

2. The microfluidic device of claim 1, further comprising:
a controller configured to control the selectively opening and closing each valve of the plurality of valves to selectively allow air to be released from the channels connected to the respective valve.

3. The microfluidic device of claim 1,
wherein the plurality of valves comprises a first valve connected to the mixing chamber, a second valve connected to the sample collection chamber, and a third valve connected to the waste connection chamber.

4. The microfluidic device of claim 1,
wherein the biomolecules comprise biomolecules selected from a group of biomolecules consisting of: microvesicles, protein, DNA, antibody, and antigen.

5. The microfluidic device of claim 3,
wherein the first valve is configured to release air from the mixing chamber and allow liquid to flow into the mixing chamber when the first valve is open.

6. The microfluidic device of claim 3,
wherein the third valve is configured to release air from the waste collection chamber and allow liquid to flow from the mixing chamber via the binding member to the waste collection chamber when the third valve is open.

7. The microfluidic device of claim 3,
wherein the second valve is configured to release air from the sample collection chamber and allow liquid to flow from the mixing chamber via the binding member to the sample collection chamber when the second valve is open.

8. The microfluidic device of claim 1,
wherein the binding member comprises particles coated with at least one of streptavidin, antibody or antigen.

9. The microfluidic device of claim 8,
wherein the particles comprise at least one of polystyrene beads, glass beads or bumps formed on a substrate surface.

10. The microfluidic device of claim 1,
wherein the microfluidic device is configured to wash out other particles by 1×PBS.

11. The microfluidic device of claim 1,
wherein the microfluidic device is configured to elute biomolecules out by flowing elusion solution through the binding member.

12. A method for controlling a microfluidic device, the microfluidic device comprising a plurality of valves connected to respective channels, a plurality of chambers, comprising a mixing chamber, a sample collection chamber, and a waste collection chamber, and a binding member configured to bind biomolecules, the method comprising:
controlling flow of a liquid between the plurality of chambers by selectively opening and closing each valve of the plurality of valves to selectively allow air to be released from the channels connected to the respective valve.

13. The method of claim 12, further comprising:
controlling the selectively opening and closing each valve of the plurality of valves to selectively allow air to be released from the channels connected to the respective valve.

14. The method of claim 12,
wherein the plurality of valves comprises a first valve connected to the mixing chamber, a second valve connected to the sample collection chamber, and a third valve connected to the waste connection chamber.

15. The method of claim 12,
wherein the biomolecules comprise biomolecules selected from a group of biomolecules consisting of: microvesicles, protein, DNA, antibody, and antigen.

16. The method of claim 14,
wherein the first valve, when it is open, allows release of air from the mixing chamber and allows liquid to flow into the mixing chamber.

17. The method of claim 14,
wherein the third valve, when it is open, allows release of air from the waste collection chamber and allows liquid to flow from the mixing chamber via the binding member to the waste collection chamber.

18. The method of claim 14,
wherein the second valve, when it is open, allows release of air from the sample collection chamber and allows liquid to flow from the mixing chamber via the binding member to the sample collection chamber.

19. The method of claim 12,
wherein the binding member comprises particles coated with at least one of streptavidin, antibody or antigen.

20. The method of claim 19,
wherein the particles comprise at least one of polystyrene beads, glass beads or bumps formed on a substrate surface.
